(19) United States
(12) Patent Application Publication
(10) Pub. No.: US 2006/0271234 A1
(43) Pub. Date: Nov. 30, 2006

(54) DOCK MANAGEMENT SYSTEM AND METHOD

(75) Inventors: Mark Gaug, Vestal, NY (US); Reed Durand, Owego, NY (US); Richard G. Fairbrother, Vestal, NY (US); Ronald L. Binning, Orlando, FL (US)

Correspondence Address: GREENBLUM & BERNSTEIN, P.L.C., 1950 ROLAND CLARKE PLACE, RESTON, VA, 20191, US

(73) Assignee: LOCKHEED MARTIN CORPORATION, Bethesda, MD (US)

(21) Appl. No.: 11/420,662

(22) Filed: May 26, 2006

Related U.S. Application Data
(60) Provisional application No. 60/685,485, filed on May 31, 2005.

(51) Int. Cl. G06F 7/00

(52) U.S. Cl. 700/213

(57) ABSTRACT

A system comprising a device generating at least one of a storage assignment and a movement schedule for each of a plurality of items based on item information and scheduling processes and an interface for displaying the generated storage assignments and movement schedules. The instant abstract is neither intended to define the invention disclosed in this specification nor intended to limit the scope of the invention in any way.

### REFERENCE TO RELATED APPLICATION

This application claims priority to U.S. Provisional Patent Application No. 60/685,485, filed on May 31, 2005, the disclosure of which is incorporated by reference herein in its entirety.

### BACKGROUND OF THE INVENTION

1. Field of the Invention

The present invention relates generally to a management system and, more specifically, to the management and processing of pallets and containers through a facility.

2. Background Description

The delivery of mail such as letters, catalogs, advertisements, parcels and a host of other articles have increased exponentially over the years. These mail pieces are known to be critical to commerce and the underlying economy. It is thus critical to commerce and the underlying economy to provide efficient delivery of such mail in both a cost effective and time efficient manner. This includes, for example, managing and processing the flow of mail through facilities. By efficiently managing and processing the flow of mail and other pallets through postal facilities, the delivery of mail and other articles can be provided in an orderly and effective manner.

In current postal facilities, such as, for example, a Processing and Distribution Center (PDC), the managing and processing includes, for example, receiving, temporarily storing, and transporting pallets and containers that contain mail. More specifically, a PDC receives pallets and containers at its loading dock. The PDC personnel transport these pallets to internal staging areas and mark them with a processing date. When the processing date arrives, the personnel transport the pallets to a preparation area, which prepares the pallets for automated mail processing. Personnel then move the mail through several sorting operations, such as, for example, automated sorting machines, which in turn, sort the mail to a delivery route sequence.

Different postal facilities use different methods for pallet management. Typically, PDC personnel manually manage the flow of pallets through the PDC. Personnel physically label each pallet, manually assign staging locations, and rely on human memory and searching to locate pallets that must be processed for that day. Manual methods are also used to schedule, track, and account for all pallets in the system. These manual methods are often ad hoc, and can result in problems including pallets arriving late or arriving in less-than-optimal sequence for sorting and/or sequencing of mail pieces. This and similar problems associated with current manual methods compound with an increasing volume of pallets.

The introduction of automated sorting systems such as, for example, the Flats Sorting Sequencer (FSS), has provided a substantial increase in the volume of pallets handled in the PDC. Historically, a substantial portion of flats mail has not been processed through the PDC's because it was either crossed-dock (e.g., a truck to track transfer without sorting) or delivered directly to a delivery unit. However, such flats mail that historically did not visit the PDC will now be directed to the PDC for sorting in the FSS. Since flats mail generally arrives at the PDC in palletized form, the FSS thus ensures that pallet traffic in a typical PDC can be expected to increase by at least 50%. And, as described above, this increased volume can, and likely will, overwhelm the current manual methods of pallet management and processing.

Accordingly, there is a need for more efficient managing and processing of pallets and other containers at postal facilities.

### SUMMARY OF THE INVENTION

According to a first aspect of the invention, there is a system comprising a device generating at least one of a storage assignment and a movement schedule for each of a plurality of items based on item information and scheduling processes and an interface for displaying the generated storage assignments and movement schedules.

According to a second aspect of the invention, there is a computer program product comprising a computer useable medium having a computer readable program, wherein the computer readable program when executed on a computer causes the computer to generate at least one of a storage assignment and a movement schedule for each of a plurality of items based on item information and scheduling processes.

According to a third aspect of the invention, there is a method comprising obtaining information about at least one item of a plurality of items, generating item management enhanced information for each of the plurality of items based on the obtained information, and managing the storage and movement of the plurality of items based at least partly on the item management enhanced information.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 represents an aspect of the invention used in an environment;

FIG. 2 is an overview of the invention;

FIGS. 3A-3B are flow diagrams depicting steps of the invention;

FIGS. 3C-3F depict exemplary interfaces according to the invention;

FIG. 4A is a flow diagram depicting steps of the invention;

FIGS. 4B-4D depict exemplary interfaces according to the invention;

FIG. 5A is a flow diagram depicting steps of the invention; and

FIGS. 5B-5C depict exemplary interfaces according to the invention.

### DETAILED DESCRIPTION OF EMBODIMENTS OF THE INVENTION

The invention is directed to a management system and method for managing pallets in a facility. More specifically, the invention relates to a management system and method for managing the processing and flow of pallets through a facility. Although the invention is described with respect to postal facilities and pallets of mail, it is understood that other applications such as warehousing and storage applications are also contemplated for use with the invention. Also, the invention is not limited to pallets, but can be implemented for other items, such as, for example, containers, cartons, trays, individual objects, etc.

In embodiments, the invention comprises a system and method that integrates various systems to provide an overview of existing pallets and rolling stock, expected pallets and rolling stock, and sortation equipment capacity and predicted throughput. In one aspect, the invention utilizes existing databases to efficiently identify staging area assignments, schedule internal material deliveries, automatically calculate internal plant routing of materials, notify when internal delivery commitments can not be met, and incorporate internal delivery verification, to name a few features. This information can then be used to perform numerous tasks such as, for example, storing, tracking, and managing pallets on the dock and throughout the sortation process, predicting workload, generating and monitoring sortation schedules. Additionally, embodiments of the invention automatically provide staging assignments for incoming pallets, provide staging areas within the existing facility footprint, schedule and track pallets from the dock to the point of consumption, assist in scheduling and tracking of sorting operations, alert personnel when priorities and schedules cannot be met, and generate alternate processing recommendations in the event of exception conditions such as sortation system failures and pallet cancellation. The invention, when utilized, is further designed to reduce manual handling of pallets and meet overall delivery commitments.

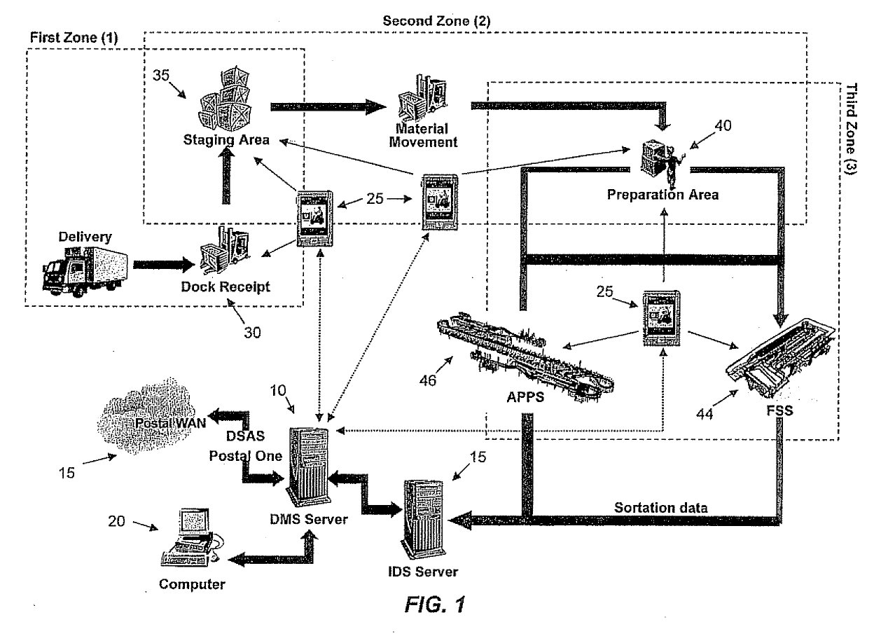

FIG. 1 shows an illustrative implementation of the invention in which the Dock Management System (DMS) is integrated into a postal facility. A server is generally designated as reference numeral 10 and is configured to contain the logic and business rules of the system, interface with internal and external databases 15, and interface with other system components, such as, for example, computers 20 and a personal data assistants (PDAs) 25 that are used by dock receipt personnel, material movement personnel, and sorting machine operators, amongst others. In embodiments, the server may equally or alternatively be a handheld device with a memory processor capable of performing the functions described herein. For all of the purposes, though, reference hereinafter will be made to a server 10.

In embodiments, the server 10 generates storage assignments, movement schedules, and sortation schedules for all pallets in the facility based on existing information and information received when pallets arrive at the dock. Facility personnel view these assignments and schedules via interfaces, such as computers 20 and PDAs 25, while handling the pallets within the facility. Facility personnel also communicate data to the server 10 via interfaces, whereby the data is used as input for the generated assignments and schedules for each pallet in the facility. In embodiments, the interface may comprise the server.

In the illustrative implementation depicted in FIG. 1, the facility includes a dock receipt area 30, staging area 35, preparation area 40, sortation machinery, such as, for example, a Flats Sorting Sequencer (FSS) 44 and Automated Package Processing System (APPS) 46, and may be divided into different zones such as First (1), Second (2), and Third (3) Zones. It should be understood that these zones are but one illustrative example, and that different zones are contemplated and can be used with the invention. In the example of FIG. 1, the First Zone (1) includes the dock receipt area 30 where deliveries of incoming pallets to the facility are received. In embodiments, facility personnel utilize an interface, such as the PDA 25, to access (e.g., view) server-generated information regarding anticipated deliveries of incoming pallets. Personnel also use the interface to record information of actually delivered incoming pallets and communicate this information to the server 10.

Still referring to FIG. 1, the First Zone (1) may also include the staging area 35. In embodiments, the staging area 35 is an area for the physical storage of incoming pallets, and may include, for example, shelving that is tailored to the individual facility to make efficient use of existing space. Individual shelving units may include an associated identification, such as a barcode, that is usable as data by the server 10. In embodiments, personnel use an interface (e.g., PDA 25) to view server-generated storage assignments for incoming pallets, and subsequently deliver the pallets to the assigned location (e.g., a particular shelf unit in the staging area 35). The location of each placed pallet may also be recorded and provided to the server.

The Second Zone (2) may include intra-facility movement of pallets, such as, for example, moving pallets from the staging area 35 to a preparation area 40. In embodiments, facility personnel use an interface (e.g., PDA 25) to view server-generated schedules that notify when a particular pallet is to be moved, where it is currently located, and where to move it to.

The Third Zone (3) may include processing, such as, for example, where pallets are consumed by sorting machines (e.g., FSS 44 and APPS 46) such that the pieces of mail of a pallet are sorted for delivery. In embodiments, facility personnel use an interface (e.g., PDA 25) to view server-generated schedules that notify when to process an pallet and where to find that pallet.

Thus, in the implementation of the invention shown in FIG. 1, the DMS, including the server 10 and interfaces, such as computers 20 and PDAs 25, provides for improved handling and managing of pallets throughout the facility. More particularly, the DMS provides improved handling and management of pallets by generating storage assignments, movement schedules, and sortation schedules that can be accessed and utilized by personnel throughout the facility, to name a few.

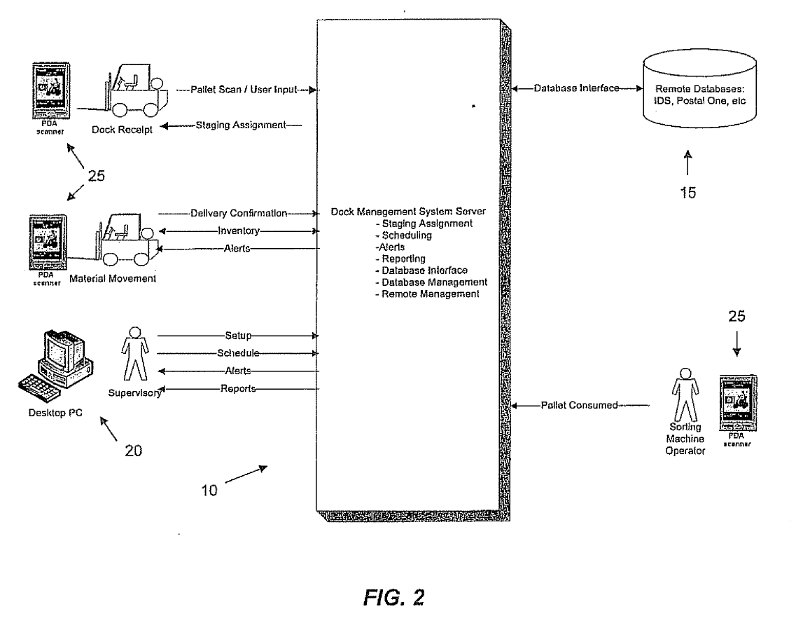

FIG. 2 shows an overview of the invention independent of any environment. The DMS includes the server 10 that is configured to contain logic and business rules of the system, interface with internal and external databases, and provide database management and remote system management. For example, the server 10 generates storage assignments for pallets in a facility, creates schedules for moving and processing pallets, and generates alerts, among other things.

The server 10 may be any type of server and comprises software that provides a highly configurable interface that is usable to access and process data from multiple remote databases 15. In embodiments, these databases may include well known databases utilized by the U.S. Postal Service such as, for example, Integrated Data System (IDS), PostalOne, Facility Access and Shipment Tracking system (FAST), and Drop Shipment Appointment System (DSAS). The data accessed from the databases 15 may include expected pallet delivery information, individual pallet characteristics, sortation information, process status, historical throughput information, and sort volume predictions, amongst others. It should be recognized by those of skill in the art that the server 10 can equally interface and manage data of other databases.

As further shown in FIG. 2, the server 10 is linked to and interacts with other system components, including one or more computers 20 and one or more PDAs 25. The computer 20 may comprise any conventional personal computer (e.g., desktop, laptop, handheld, etc.) and includes software or programming in the form of a Supervisor Application (SA) that allows it to interface with the server 10. Through the computer 20, a user may provide input to the server 10 in the form of system setup and configuration, scheduling data, scheduling rules, etc., in addition to receive output from server 10 in the form of storage assignments, schedules, alerts and reports, to name a few. The computer 20 may include conventional output devices, such as displays and printers, for the display of information.

FIG. 2 also shows plural PDAs 25, which may comprise any conventional personal data assistant, and includes software or programming that allows it to interface with the server 10. In embodiments, each PDA 25 includes an input device, such as, for example, a barcode scanner, that allows the PDA 25 to retrieve data from pallets and facility locations that have an associated barcode. Although the input device is described herein as a barcode scanner, it is understood that the PDA 25 could retrieve data in other ways, such as, for example, by manual input (e.g., typing, stylus, etc.), radio frequency identification (RFID) devices, etc.

In implementations, facility personnel use the PDA 25 to scan, or record in other manners, information of incoming pallets, and send this information to the server 10. Facility personnel also use the PDA 25 to send intra facility pallet movement data and pallet consumption data to the server 10. In return, the server 10 generates storage assignments, schedules, inventory, and alert information that can be accessed by the facility personnel via interfaces, such as computers 20 and PDAs 25.

In embodiments, the server 10 utilizes various data from the databases 15 and interfaces (e.g., computers 20 and PDAs 25) to generate storage assignments and schedules of all of the pallets within the facility. The various data may include, for example: expected pallet delivery date and time, characteristics of pallets (e.g., flats, parcels, first class, priority, etc.), inventory and location of pallets within the facility, available pallet storage space within the facility, target processing deadlines for each pallet, sortation information, processing machine status (e.g., normal, behind schedule, inoperative for maintenance, etc.), historical throughput information for each processing machine, pre-programmed sort plans of processing machines, and sort volume predictions, among others. The DMS is dynamic in that the server-generated storage assignments and schedules may change as the various data changes. Thus, the DMS provides a constantly-updating overview of the handling and management of all of the pallets throughout a facility.

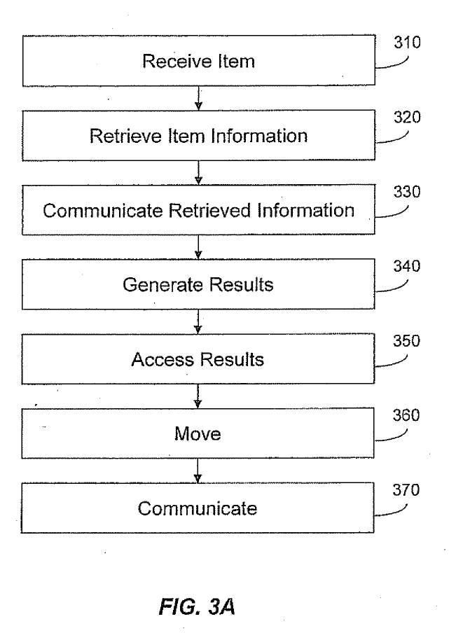

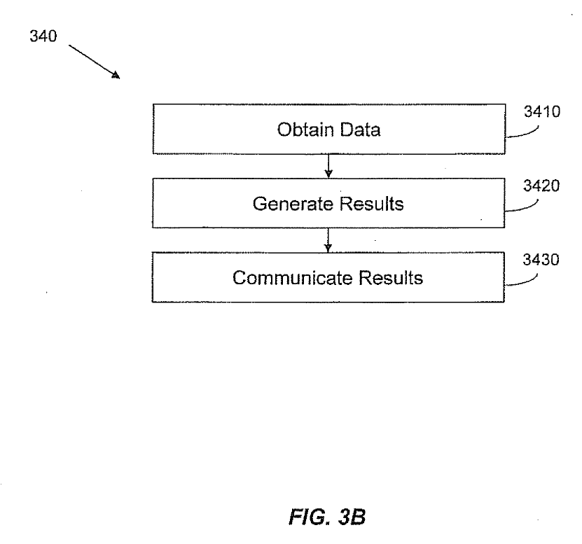

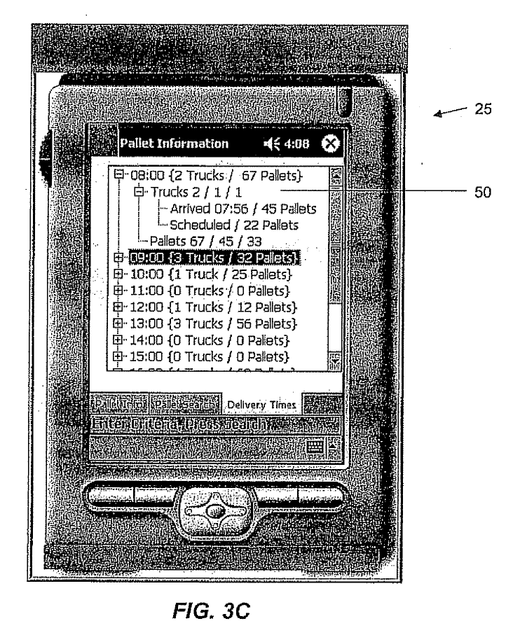

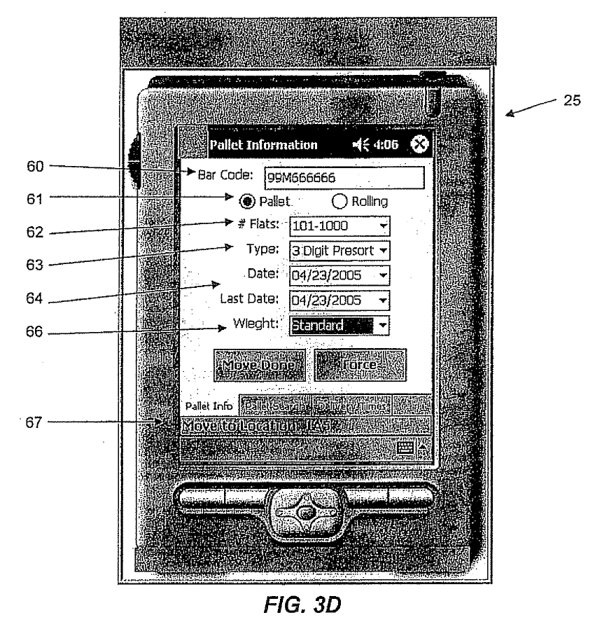

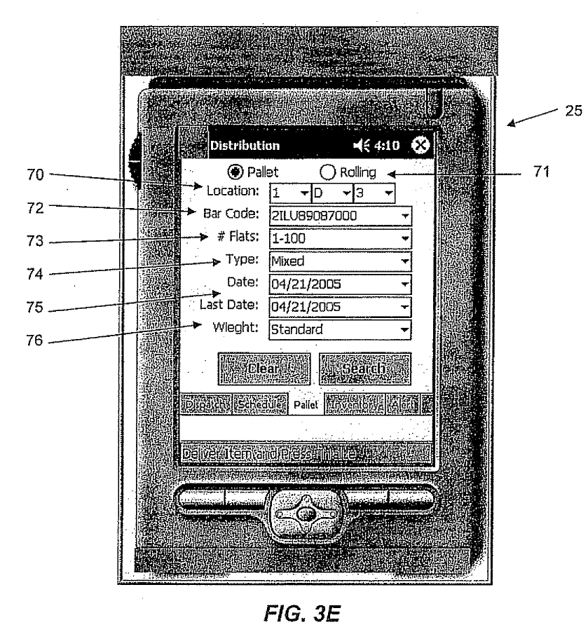

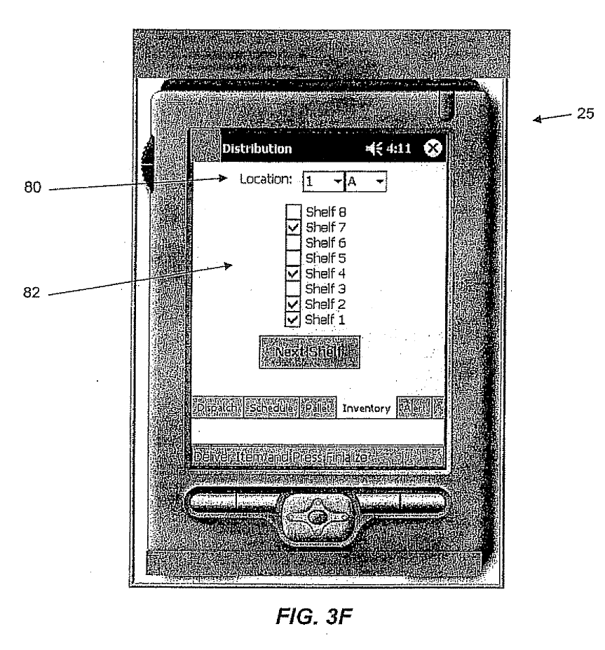

FIG. 3A is a flow diagram showing steps implemented by aspects of the invention. The steps of embodiments of the invention, as depicted in FIG. 3A, and other flow diagrams, may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation or the sort computer over the Internet or some other type of network. FIG. 3A, and the other flow diagrams, may equally represent a high-level block diagram of the system of the present invention, implementing the steps thereof.

### First Zone

The steps depicted in the flow diagram of FIG. 3A are related to the management and handling of pallets in the First Zone (1) of the illustrative implementation of the invention. For example, the First Zone (1) includes receiving incoming pallets at dock receipt 30, and storing pallets in the staging area 35.

In step 310, an item is received. In embodiments, dock receipt personnel receive delivered incoming pallets, such as, for example, from delivery trucks.

In step 320, item information is retrieved. For example, dock receipt personnel use an interface to retrieve information from each incoming pallet. In embodiments, the interface is a PDA 25 comprising a barcode scanner that reads a barcode on each incoming pallet. In alternative embodiments, the interface could be other devices, such as a computer 20, and information may be retrieved without the use of barcodes, such as, for example, by manual input, RFID, etc. The retrieved information may be, for example, the type of mail a pallet contains (e.g., flats, parcels, etc.), the class of mail it contains (e.g., first class, priority, etc.), and the target processing deadline (e.g., date and time) of the mail it contains. In this manner, in embodiments, the PDA 25 also serves as an interface that accepts input data regarding the actual receipt of pallets into the facility.

In step 330, the retrieved information is communicated, such as, for example, to the server 10. In embodiments, the interface (e.g., PDA 25) communicates the retrieved information to the server 10 in any known way, including, for example, wireless transmission, docking station, local area network (LAN), Internet, Ethernet, etc.

In step 340, results are generated, such as, for example, placement of incoming pallets at a location or movement of pallets. In embodiments, the server 10 uses the retrieved information in conjunction with the other data, such as, for example, from the databases 15, and possibly from other interfaces, to generate a storage assignment and schedule for the incoming pallet. In this manner, each incoming pallet is inducted into the overall management and handling system of the DMS.

In step 350, the generated results are accessed by personnel. In embodiments, dock receipt personnel utilize an interface (e.g., PDA 25) to access (e.g., view) the storage assignment (e.g., assigned location within the facility to place the pallet) for an incoming pallet. In embodiments, the storage assignment (and all other server-generated data) is accessible by the interface from a central data storage location (described below).

In step 360, the item is moved to an assigned location. For example, in embodiments, the dock receipt personnel deliver (e.g., physically move) the pallet to the assigned location.

In step 370, information regarding the moved item is communicated to the server 10 or other processor. For example, in embodiments, personnel use the interface (e.g., PDA 25) to communicate delivery of the pallet to the assigned location by, for example, scanning a barcode associated with the assigned location and communicating this data to the server 10. This information is entered into the DMS to allow future retrieval of the pallet, when necessary.

FIG. 3B depicts exemplary non-limiting details of step 340. In step 3410, data is obtained. In embodiments, the server 10 obtains various data, such as, for example, by accessing databases, receiving input from interfaces, accessing central data storage, and/or accessing other memory. For example, the server 10 may receive data from the databases 15 and/or from the interfaces, such as, for example, computers 20 and PDAs 25.

The DMS, via the server 10, is capable or performing various operations with the available data. In embodiments, the operations include data translation, staging assignment, scheduling assignment, data storage, and conflict resolution. In an illustrative example, the server 10 performs data translation that operates to translate user input from the various databases 15 and interfaces (e.g., computer 20, PDA 25) to machine language that is usable by the server 10, as is well known to those of skill in the art. Thus, for example, step 3410 may include the operation of data translation such that the server 10 may utilize the various data.

In step 3420, the server 10 generates storage assignments and schedules for pallets in the facility. This may be accomplished, for example, with the data from step 3410. For example, the server 10 performs staging assignment that operates to assign each incoming pallet (e.g., pallet) to a physical location in the facility (e.g., a particular shelf in the staging area 35), based upon DMS data such as, for example, available pallet storage space within the facility, anticipated future incoming pallets, characteristics of the pallet, time needed to process the pallet, schedules of other pallets, deadline for processing the pallet, status of machines needed to process the pallet, pre-programmed sort plans of machines, etc. Based upon such data, the server 10 determines an optimum location for the pallet within the facility and assigns the pallet to that location. For example, if a pallet of high priority is received at dock 30 and needs to be processed by the APPS within three hours, then the server 10 may, via the staging assignment, assign the pallet to an available storage location that is closest to the APPS. Conversely, if a pallet of low priority arrives that need not be processed for two days, then the server 10 may, via the staging assignment, assign the pallet to an available storage location that is somewhat far away from the intended processing machine.

In step 3430; the server 10 communicates the generated assignments and schedules to a central data storage location. In embodiments, the server 10 operates to store all of the data, assigned locations, schedules, etc. For example, the server 10 stores the information at a central location (e.g., computer memory or database) for later recall by the server 10 and/or interfaces, such as the computer 20 and PDAs 25.

In embodiments, the DMS is not limited to generating results (e.g., performing steps 3410; 3420; and 3430) only when pallets arrive at the dock receipt 30. Results may be generated at any time, as defined by the user. For example, the steps may be performed on a routine time interval, such as every five minutes, although other times are contemplated by the invention. Also, a user may use an interface (e.g.; computer 20) to initiate the performance of the results generation steps.

Furthermore, the results generation steps are not limited to generating storage assignments for incoming pallets. The steps may involve other operations, such as scheduling and conflict resolution, to be described herein. In this way, the DMS creates an updated storage and scheduling solution for every pallet in the facility each time the steps are performed.

FIGS. 3C-3E show an exemplary use of the DMS in the First Zone. FIG. 3C shows an exemplary interface, PDA 25, displaying a schedule 50 of expected delivery times of incoming pallets to the dock receipt area 30. For example, the schedule 50 shows that at 67 pallets are expected at 8:00, 32 pallets are expected at 9:00, etc; In embodiments, the delivery times are obtained by the server, either from the databases 15 or by manual input from other interfaces (e.g., computer 20, PDA 25, etc.). In this way, personnel know when to expect incoming pallets in the dock receipt area. When an incoming pallet arrives, the interface is used to retrieve the pallet information and send this information to the server.

As depicted in FIG. 3D, the interface is then used to access storage assignment results regarding the pallet. For example, the interface shows item identification 60 (e.g., Bar Code, etc.), nature of the item 61 (e.g., pallet, rolling, etc), number of units 62, type of processing 63 (e.g., sort level, e.g., 3 Digit Presort), pertinent dates 64, weight 66 (e.g., standard, etc.) and location 67 to be moved and stored at (e.g., “1A5”). The pallet is moved to the assigned location, for example, the staging area 35, and the interface is again used to communicate the move results to the server 10.

FIGS. 3E-3F show another exemplary use of the DMS. Because the server 10 generates storage assignments for each pallet in the facility, it is possible to use the DMS to provide an inventory function. For example, as depicted by FIG. 3E, personnel can input a location 70 (e.g., “1D3”) into the interface and receive the information regarding the item that is currently at that location. The information may include, for example: item type 71, item identification 72, number of units 73, type of processing 74, pertinent dates 75, and unit weight 76, etc.

As shown in FIG. 3F, the interface can also be used to provide a quick glance at to which shelves in a particular location are empty and which are occupied by pallets. For example, personnel may input a location 80 (e.g., “1A”), and receive an overview 82 of which shelves are empty or occupied.

As seen from FIGS. 3C-3F, the interface may be interactive. For example, the PDA 25 may have scroll-down selection menus, expandable and collapsible information trees, graphic buttons, check boxes, radio buttons, menus, etc.

It will be appreciated by those skilled in the art that the DMS is a dynamic system that is constantly updating based upon changing data, and the act of assigning a pallet to a particular storage location may affect the management and handling of other pallets of the facility. For example, when a pallet is assigned to a location, then that location is no longer available for other pallets. This new data (e.g., one less storage location) may affect the results of subsequent operations of staging assignment, scheduling assignment, and conflict resolution (described herein).

### Second Zone

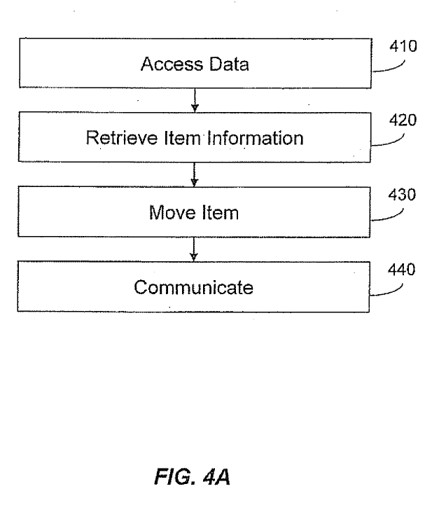

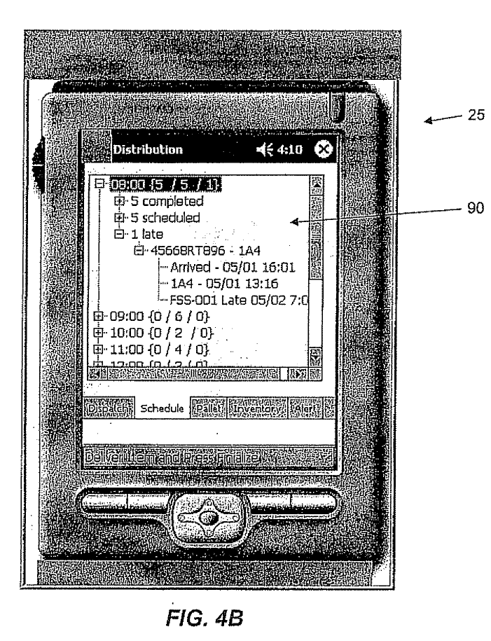

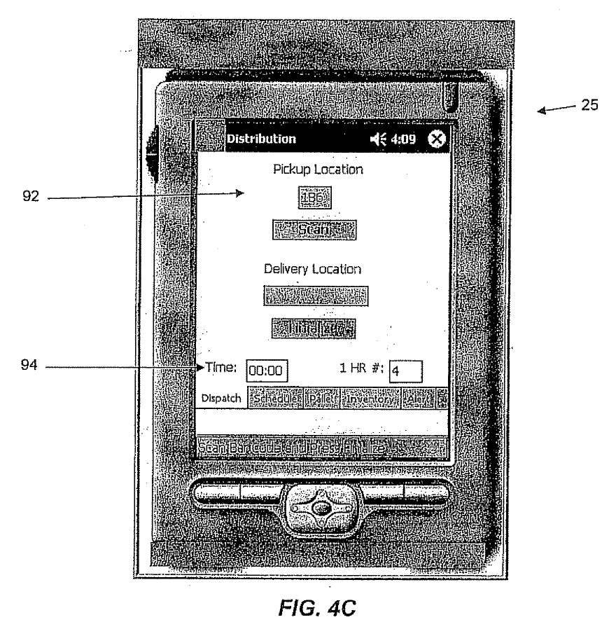

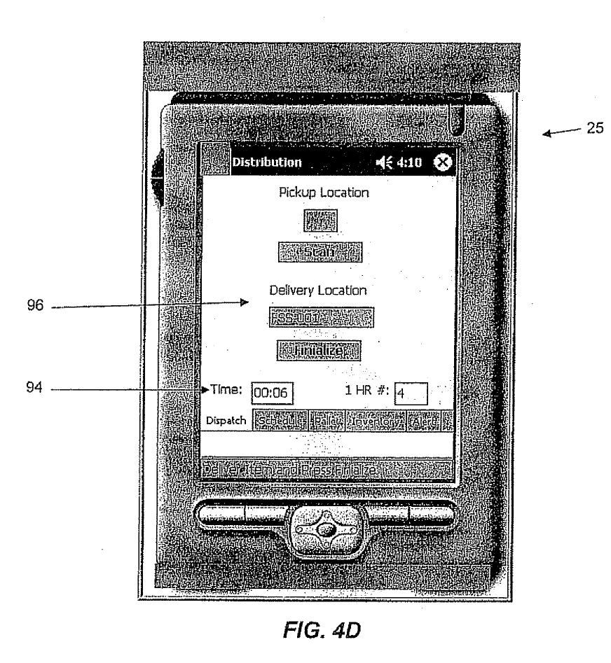

The steps depicted in the flow diagram of FIG. 4A are related to the management and handling of pallets in the Second Zone (2) of the illustrative implementation, such as, for example, pallet movement from staging areas 35 to delivery points 40, such as mail processing equipment and preparation areas.

In step 410, data is accessed by an interface, such as PDA 25. In embodiments, an interface is used to access information from the central data storage location. The interface may be, for example, computers 20 and/or PDAs 25. In embodiments, the information is a delivery schedule that contains information regarding when to move a particular pallet from one location (e.g., a shelf in the staging area 35) to another location (e.g., a preparation area 40). Transmission may be initiated by the server 10, such that the information is pushed from the server 10 of the central data storage location to the interface. Alternatively, transmission may be initiated by the interface, such that the information is pulled from the server 10 or the central data storage location to the interface.

In embodiments the delivery schedule is generated by the server 10 by way of operation of a scheduling assignment solution that resides on the server 10. For example, the server 10, via scheduling assignment, uses various data as input and produces schedules of the movements of pallets throughout various locations of the facility based primarily upon an overall time deadline for each pallet. Each pallet has a deadline (e.g., date and time) to be processed and sent out of the facility for delivery, such that the units of mail contained in the pallet can be delivered according to schedule. Based on the various data (e.g., type and/or class of mail in the pallet, location of the pallet in facility, availability of sorting machines, schedule of other pallets, pre-programmed sort plans of machines, etc.), the server 10, via scheduling assignment, applies customized rules (described below) to provide schedules for the flow of pallets through the facility to meet time deadlines and optimize available resources. In other words, the server 10 derives an optimal time and location for all the various stops that a pallet will make throughout the facility.

In embodiments, the above-mentioned customized rules may include, for example, known internal processing rates of facility machines and routing rules for pallets in the facility. Internal processing rates may include, for example, that a preparation area can process sixteen pallets per hour, or that a processing machine (e.g., FSS, APPS, etc.) can sort ten thousand flats per hour. Such processing rate information is utilized in the scheduling assignment to effectuate efficient scheduling and planning because it facilitates “as needed” or “just in time” movement of pallets within the facility. In other words, if a machine can handle sixteen pallets per hour, then it is more efficient to delivery the pallets as needed rather than delivering fifty all at one time.

In embodiments, routing rules include logical decisions that affect how a pallet is routed throughout the facility. For example, a routing rule may require that pallets containing flats be delivered to the FSS 44 because the FSS 44 sorts flats. Another routing rule may require that containers of parcels be delivered to the APPS 46. There may also be routing rules regarding the class of mail: pallets containing express mail get processed first, then pallets containing priority, then first class, etc. Additionally there may be routing rules regarding the availability of machines. For example, a routing rule may dictate that if machine “A” is unavailable (e.g., broken, overloaded, etc.) then route the pallet to machine “B”. Such routing rules are utilized in the scheduling assignment to determine the routing and scheduling of pallets through the facility.

In embodiments, the customized rules (e.g., internal processing rates, routing rules, etc.) are communicated to the server by an interface. For example, personnel may use the computer 20 to manually input the customized rules to the server 10. Alternatively, some or all of the customized rules may be derived by a computer coded program that derives the customized rules from historical data of the facility and then communicates the rules to the server 10.

In an illustrative embodiment, the server also performs conflict resolution that operates to monitor the pallets and processes of the facility and determine when a delivery deadline of a pallet cannot be met. For example, the server 10, via conflict resolution, monitors the schedules generated during scheduling assignment and the actual locations of pallets in the facility. With such data, the server 10 can determine scheduling problems in either a reactive or proactive manner. A reactive determination is when the server 10 detects that a pallet has not arrived at a scheduled location within the facility on time. A proactive determination is when the server 10 uses forward looking calculations to determine that, based upon the time required for intermediate steps, it is impossible to meet a certain deadline. In embodiments, when the server 10 determines a problem, whether reactively or proactively, it creates an alert. The alert is transmitted from the server 10 to an interface (e.g., computer 20, PDA 25, etc.) to notify personnel of the problem. At this point the personnel can take various actions, such as: do nothing because the problem is minor; cause the server 10 to generate a new optimized schedule based upon the new data; manually resolve the problem by hand processing, etc. Thus, the server 10 constantly monitors the system and alerts the personnel to problems.

Still referring to FIG. 4A, in step 420, item information is retrieved by the interface. For example, personnel use a PDA 25 to scan a barcode associated with either the pallet or the current storage location of the pallet. Step 420 may include communicating this data to the server 10 and viewing the assigned delivery location for the pallet on the interface (e.g., PDA 25). For example, upon scanning a pallet barcode, the delivery information may automatically be displayed on the PDA 25 by way of communication between the server 10 and the PDA 25.

In step 430, the item is moved from its current location to a new location. For example, this may include physically moving a pallet from the staging area 35 to the delivery point, such as, for example, a prep area 40, FSS 44, or APPS 46.

In step 440, information regarding the move is communicated. In embodiments, upon delivery of the pallet to its new location within the facility, the interface (e.g., the PDA 25) is used to communicate new location of the pallet to the server 10. For example, the PDA 25 may be used to scan a barcode of the delivery point where the pallet is delivered to, and this new location for the pallet is communicated to the server 10.

FIGS. 4B-4D show an exemplary use of the DMS in the Second Zone (2). FIG. 4B shows an exemplary interface, PDA 25, displaying a schedule 90. The schedule is generated by the server 10, and may be pushed to or pulled by the interface, as described above, For example, the schedule 90 may show that pallet number “45668RT896” arrived at location “1A4” at a certain time and is due at location “FSS-001” at a certain time. In this manner, personnel may see when and where pallets must be moved. When, according to the schedule, a pallet is to be moved, for example from staging area 35 to preparation area 40, personnel may initiate the move by scanning either a pallet barcode or a shelf barcode where the pallet is currently stored.

FIG. 4C shows an interface 25 display of a pickup location 92 after a shelf barcode corresponding to location “1B6” has been scanned. The interface display also shows a timer 94. This information is communicated to the server 10. Subsequently, as shown in FIG. 4D, the interface accesses and displays the delivery location 96 that the pallet currently located at “1B6” is to be moved to. In this example the pallet is to be moved to location “FSS-001”. The timer 94 notes the time between the pickup and delivery. After the pallet has been moved, the interface is used to communicate to the server 10 that the move has been made (e.g., the pallet is in its new location).

Thus, in embodiments, the computers 20 and/or PDAs 25 act as an interface for inputting data regarding intermediate deliveries within the facility. For example, the PDA 25 may be used to input information regarding material arrival to, and exit from, docks, staging areas, preparation areas, delivery points, and dispatch areas. This information may be manually typed, scanned via barcode, communicated via RFID, etc.

Furthermore, in embodiments, a user may monitor all aspects of the management of the facility (e.g., dock receipt, staging, material movement, sorting) via the Supervisor Application (SA) on the computer 20. For example, personnel may use the SA to setup and configure the system. For example, a user may input the customized-rules and/or other rules that affect the assignment of staging areas, when and where material is moved, sort plans, and thresholds for alerts. Additionally, the user may manually enter data that is not contained in the databases 15. Also, personnel may display and print reports that show overall system performance and health. Furthermore, personnel may use the system to aid in planning and revising schedules, and may receive alerts that warn when action is needed to meet a schedule commitment.

It will be appreciated by the skilled artisan that the DMS is a dynamic system that is constantly updating based upon changing data, and the results of scheduling assignment and/or conflict resolution may have an impact on other parts of the facility. For example, if a pallet is moved from location “A” in the staging area 35 to location “B” in a preparation area 40, then the server 10 can ascertain that there is now an open storage location at area “A” and may determine that an anticipated incoming pallet may be placed in this location upon receipt of that incoming pallet at the dock 30. As another example, if the server 10 ascertains, via scheduling assignment and conflict resolution, that the FSS 44 is behind schedule by a certain amount of time, then the sever 10 may dictate that no more pallets be moved to the preparation area of that FSS 44 until the backlog is cleared, or that pallets be routed to other machines that can handle the workload.

### Third Zone

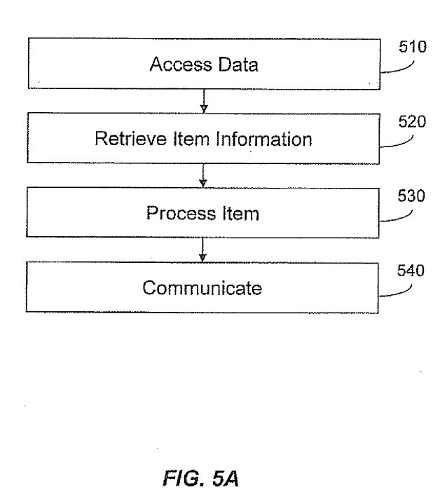

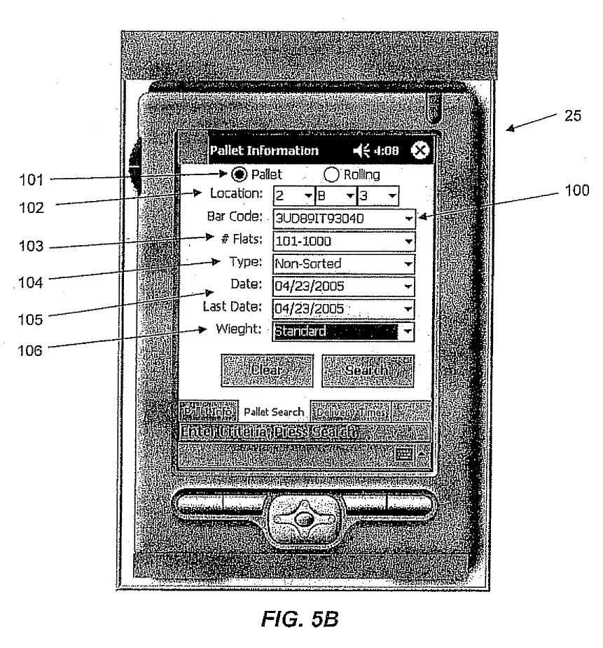

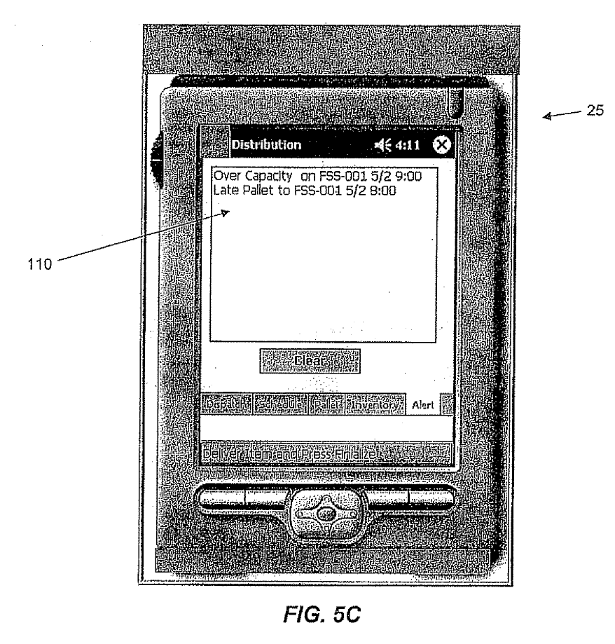

The steps depicted in the flow diagram of FIG. 5A are related to the management and handling of pallets in the Third Zone (3) of the illustrative implementation, such as, for example, consuming pallets at sorting machines.

In step 510, data is accessed from the server 10 or central data storage location by the interface, for example. The interface may be, for example, computers 20 and/or PDAs 25. In embodiments, the information is a processing schedule that contains information regarding when to process a particular pallet in a particular machine (e.g., FSS 44, APPS 46, etc.). Transmission of the information may be initiated by the server 10, such that the information is pushed from the server 10 or the central data storage location to the interface. Alternatively, transmission may be initiated by the interface, such that the information is pulled from the server 10 or the central data storage location to the interface.

In step 520, item information is retrieved by the interface. For example, personnel use a PDA 25 to scan a barcode associated with either the pallet or the current storage location of the pallet. Step 520 may include communicating this data to the server 10 and viewing the assigned processing information for the pallet on the interface (e.g., PDA 25). For example, upon scanning a pallet barcode, the processing information may automatically be displayed on the PDA 25 by way of communication between the server 10 and the PDA 25.

In step 530, the item or pallet is processed. For example, this may include consuming the contents of the pallet in a processing machine. This may include depositing the parcels that are contained in a pallet into the APPS 46, such that the parcels are sorted and the pallet is now empty.

In step 540, information regarding the processing of the item is communicated. In embodiments, upon processing of the pallet, the interface (e.g., the PDA 25) is used to communicate the processing of the pallet to the server 10. For example, the PDA 25 may be used to scan a barcode of the processing machine in which the pallet is processed, and this information is communicated to the server 10. Alternatively, the processing machine (e.g., APPS 46) may include a device, such as a barcode scanner, that is capable of retrieving pallet information. For example, the processing machine may automatically capture and communicate the pallet information to the server (either directly or indirectly via a database), without the need for scanning with a PDA 25. In this manner, whether the information is captured by a PDA 25 or the processing machine, the DMS knows that the pallet is empty and no longer needs to be accounted for.

FIGS. 5B-5C show an exemplary use of the DMS in the Second Zone. When, according to a processing schedule, it is time process a pallet, the processing machine operator may use the interface to locate the pallet. FIG. 5B shows an exemplary interface, PDA 25, displaying a search result. For example, the processing machine operator may wish to locate pallet number “3UD89IT93040”. For example, as depicted by FIG. 3E, personnel can input an item identification 100 into the interface and receive information including, for example: item type 101, item location 102, number of units 103, type of processing 104, pertinent dates 105, and unit weight 106, etc. The interface may be used to access the server 10 and/or central data storage, and access and display the current location of that pallet. In this way, personnel may locate any pallet in the facility. Once the pallet has been located, it can be processed, and the interface can be used to communicate such to the server 10 (or the processing machine may automatically communicate such to the server 10).

FIG. 5C shows an exemplary interface, PDA 25, displaying an alert 110. For example the alert 110 may indicate that a machine or location is over capacity, that a pallet is late, etc. As previously described, the server 10 may, via conflict resolution, generate alerts when a pallet is late or will be late. In this manner the DMS warns personnel that remedial action should be undertaken.

It will be appreciated by those skilled in the art that the DMS is a dynamic system that is constantly updating based upon changing data, and the act of processing one pallet may have an impact on the management and handling of other pallets of the facility. For example, when a pallet is processed, then the data that is used by all of the operations of the server 10 changes because the storage location that the pallet occupied is now vacant and the processing machine no longer has that pallet in its queue. This new data (e.g., an open storage location and a freed-up machine) may affect the results of subsequent operations of staging assignment, scheduling assignment, and conflict resolution, etc.

Thus, in embodiments, the invention presents significant advantages to the overall management of systems in a facility. For example, by implementing the invention, the system captures the barcode or other information of any pallet, container, etc., that arrives at a dock or other location, and correlates it to pertinent data in the database, thus allowing the system to display to personnel, via interfaces such as PDAs 25 and computers 20, assigned staging area locations, schedules of dock deliveries, and alerts for priority or late pallets that should be delivered directly to other areas (e.g., processing), etc.

Furthermore, the invention provides improved handling and management of pallets, containers, or other items or objects, in a facility by providing personnel with the exact location to look for a needed pallet, container, object, etc. For example, the invention tracks the location of every pallet from staging area to delivery point, thereby reducing the number of lost pallets. Additionally, the invention allows personnel to view anticipated and real-time updated schedules that show when and where pallets need to be delivered, so that personnel can plan ahead accordingly. Also, through the use of historic information, the system can alert personnel when an internal delivery commitment could be in jeopardy.

The invention provides benefits of efficient management and processing of inventory through utilization of data. For example, the invention accomplishes this by assigning pallets to known locations, scheduling pallet deliveries, providing easy operator access to pallet information, and providing visibility to all pallets, and monitoring pallets as they move through the processing facility.

While the invention has been described in terms of embodiments, those skilled in the art will recognize that the invention can be practiced with modifications and in the spirit and scope of the appended claims.

What is claimed:

1. A system, comprising:
a device generating at least one of a storage assignment and a movement schedule for each of a plurality of items based on item information and scheduling processes and an interface for displaying the generated storage assignments and movement schedules.

2. The system of claim 1, wherein the interface transmits at least a portion of the item information to the device.

3. The system of claim 1, wherein the interface captures at least a portion of the item information and transmits the at least a portion of the item information to the device.

4. The system of claim 1, wherein the interface is the device.

5. The system of claim 4, wherein the interface comprises at least one of processing capability and information capture capability.

6. The system of claim 1, wherein the generated storage assignments are based on at least one of: pre-existing item information, already stored items, known empty spaces, and deadlines for processing.

7. The system of claim 1, wherein the device accesses pre-stored data including at least one of: expected item delivery information, individual item characteristics, sortation information, process status, historical throughput information, and sort volume predictions.

8. The system of claim 1, wherein the device generates an alert when any of the plurality of items falls behind a schedule.

9. The system of claim 1, wherein the device maintains an inventory of the plurality of items.

10. The system of claim 1, wherein the device performs conflict resolution.

11. The system of claim 11, wherein the conflict resolution is based upon pre-defined rules.

12. The system of claim 10, wherein the conflict resolution is at least one of proactive and reactive.

13. The system of claim 10, wherein, based on the conflict resolution, the device generates an updated schedule for items to be processed.

14. The system of claim 1, wherein the plurality of items comprise mail pieces.

15. The system of claim 1, wherein the device tracks scheduling processes.

16. The system of claim 15, wherein the scheduling processes include movement of the plurality of items through a facility.

17. The system of claim 1, wherein the generated movement schedules are based on at least one of: types of products in a facility, machine availability, deadlines for processing, sort level of items.

18. The system of claim 1, wherein the interface is interactive with an operator.

19. The system of claim 1, wherein at least one of the device and the interface stores the generated storage assignments and movement schedules to a separate data storage location.

20. The system of claim 19, wherein the interface accesses the separate data storage location to obtain the generated storage assignments and movement schedules.

21. The system of claim 1, wherein the item information comprises information transmitted from the interface to the device and information gathered from at least one database that is not comprised in the device.

22. The system of claim 1, wherein the device generates a processing schedule for each of the plurality of items.

23. The system of claim 1, wherein the device and the interface are configured to communicate with each other over a communication network.

24. The system of claim 1, wherein the device schedules items to be processed at different locations at pre-determined times based on at least one of: machine availability, items in process, and items to be processed.

25. A computer program product comprising a computer useable medium having a computer readable program, wherein the computer readable program when executed on a computer causes the computer to:
generate at least one of a storage assignment and a movement schedule for each of a plurality of items based on item information and scheduling processes.

26. A method, comprising:
obtaining information about at least one item of a plurality of items;
based on the obtained information, generating item management enhanced information for each of the plurality of items;
managing the storage and movement of the plurality of items based at least partly on the item management enhanced information.

27. The method of claim 26, wherein the item management enhanced information is at least one of a storage assignment and a movement schedule in a facility.

28. The method claim 27, further comprising displaying at least one of the storage assignment and movement schedule on an interface.

29. The method of claim 26, wherein the obtained information is data that is gathered at the arrival or is pre-stored prior to the arrival of at least some of the plurality of items.

30. The method of claim 26, wherein the obtaining comprises receiving information from an interface and gathering information from a database.

31. The method of claim 26, wherein the generating is based on at least one of: pre-existing data, already stored items, known empty spaces, and deadlines for processing items.

32. The method of claim 26, further comprising generating an alert when any of the plurality of items falls behind a schedule.

33. The method of claim 26, further comprising generating an inventory of the plurality of items.

34. The method of claim 26, further comprising performing conflict resolution.

35. The method of claim 34, wherein the conflict resolution is based upon pre-defined rules.

36. The system of claim 34, further comprising generating an updated schedule for items to be processed based upon the conflict resolution.

37. The method of claim 26, wherein the plurality of items comprise mail pieces.
